(19) United States
(12) Patent Application Publication
(10) Pub. No.: US 2016/0350490 A1
(43) Pub. Date: Dec. 1, 2016

(54) DYNAMIC INTEGRATION OF DISPARATE HEALTH-RELATED PROCESSES AND DATA

(71) Applicant: The Quantum Group, Inc., Lake Worth, FL (US)

(72) Inventors: Pedro MARTINEZ, Boca Raton, FL (US); Noel I. GUILLAMA, Wellington, FL (US)

(73) Assignee: Noel I. Guillama, Wellington, FL (US)

(21) Appl. No.: 15/163,523

(22) Filed: May 24, 2016

Related U.S. Application Data
(63) Continuation of application No. 12/418,689, filed on Apr. 6, 2009, now abandoned.

(51) Int. Cl. G06F 19/00

(52) U.S. Cl. CPC G06F 19/322; G06F 19/325; G06F 19/328

(57) ABSTRACT

A computer-implemented method for integrating disparate health-related procedures and health-related data derived from disparate sources for an individual patient is provided. The method includes generating an integrated patient profile comprising procedure-specific data obtained by performing one or more health-related procedures on the patient. Additionally, the method includes accessing health-related data pertinent to the patient, and creating an integrated patient record based upon the integrated patient profile and health-related data.

### CROSS-REFERENCE TO RELATED APPLICATIONS

This application is a continuation of U.S. Non-provisional patent application Ser. No. 12/418,689, which was filed Apr. 6, 2009, which claims the benefit of U.S. Provisional Patent Application No. 61/043,311, which was filed Apr. 8, 2008, each of which is hereby incorporated by reference in its entirety as if fully set forth herein.

### FIELD OF THE INVENTION

The present invention is related to the fields of data processing, and more particularly, to techniques for integrating disparate health, medical, and lifestyle information and processes.

### BACKGROUND OF THE INVENTION

There is increasing recognition among scientists and healthcare professionals that an individual's health, or overall wellness, can be enhanced by treating the individual as a whole person, not just a disease or a collection of symptoms. A corollary to this approach is that when many different factors, such as the individual's lifestyle and physical environment, are properly taken into account and tracked over time, healthcare professionals can provide better diagnosis, treatment, and health-improving recommendations for the individual.

While the benefit of this approach is appreciated by many, there yet remain obstacles to putting it into practice. A critical obstacle is that taking into account a multiplicity of factors over time relating to an individual's wellness requires that data be obtained from a wide array of disparate sources. Moreover, optimal use of such data requires that the data be integrated, stored, and updated efficiently over time. As yet there are no effective and efficient systems or methods for meeting these requirements. In most instances, relevant information sources and healthcare processes are “siloed” in the sense that there is little or no inter-communication among disparate information sources and various healthcare-related processes.

Moreover, an individual's wellness often depends on the various health-related processes and medical procedures that the individual undergoes at various times. Conventionally, the different processes and procedures have been viewed in isolation, rather than as a larger, coherent process aimed at a common goal of providing the individual with an optimal level of wellness. Moreover, there has been little or no attempt to integrate the processes and procedures, which might collectively be termed wellness transactions, with different sources of relevant information. Accordingly, there is a need for an effective and efficient mechanism for integrating these various processes and procedures with one another, as well as with a wide array of relevant data derived from different information sources.

### SUMMARY OF THE INVENTION

The invention is directed to systems, methods, and computer products for dynamically integrating health-related systems, such as those used in medical testing and treatment with disparate health-related data, such as that pertaining to an individual's lifestyle or environment. An aspect of the invention is an architecture for electronic information and transaction exchange. This architecture can provide a uniform mechanism for the creation, capture, and analysis of a wide variety of process-related and health-relevant data pertinent to a patient. With the invention, an individual patient can be viewed in a manner analogous to a product that is processed through a virtual production or supply chain.

One embodiment of the invention is a system for integrating disparate health-related procedures and health-related data derived from disparate sources for an individual patient. The system can include a profile-generating module for generating an integrated patient profile comprising procedure-specific data obtained by performing one or more health-related procedures on the patient. The system also can include an electronic interface for accessing health-related databases comprising health-related data pertinent to the patient. The system further can include a record-generating module for generating an integrated patient record based upon the integrated patient profile and health-related data.

Another embodiment of the invention is a computer-implemented method for integrating disparate health-related procedures and health-related data derived from disparate sources for an individual patient. The method can include generating an integrated patient profile comprising procedure-specific, data obtained by performing one or more health-related procedures on the patient. Additionally, the method can include accessing health-related data pertinent to the patient, and creating an integrated patient record based upon the integrated patient profile and health-related data.

Still another embodiment of the invention is a computer-readable medium in which is embedded computer-readable code that, when loaded on a computer, causes the computer to perform the following steps: generating an integrated patient profile comprising procedure-specific data obtained by performing one or more health-related procedures on the patient; accessing health-related data pertinent to the patient; and creating an integrated patient record based upon the integrated patient profile and health-related data.

### BRIEF DESCRIPTION OF THE DRAWINGS

There are shown in the drawings, embodiments which are presently preferred. It is expressly noted, however, that the invention is not limited to the precise arrangements and instrumentalities shown in the drawings.

FIG. 1 is a schematic view of an exemplary network environment in which a system for integrating disparate health-related procedures and health-related data, according to one embodiment of the invention, is utilized.

FIG. 2 is a schematic view of a system for integrating disparate health-related procedures and health-related data derived from disparate sources for an individual patient, according to one embodiment of the invention.

FIG. 3 is a schematic view of certain operative features of the system illustrated in FIG. 2 and operating in the exemplary network environment shown in FIG. 1.

FIG. 4A is a schematic view of an exemplary integrated patient record generated, according to another embodiment of the invention, by a system for integrating disparate health-related procedures and health-related data derived from disparate sources, and FIG. 4B shows a schematic view of the various components in the system.

FIG. 5 is a flowchart of exemplary steps in a method for integrating disparate health-related procedures and health-related data derived from disparate sources for an individual patient, according to yet another embodiment of the invention.

### DETAILED DESCRIPTION

The invention is directed to systems and methods for dynamically integrating health-related systems, such as those used in medical testing and treatment (e.g., physician's notes and medial images and test results) with health-related data , such as that pertaining to an individual's lifestyle and environment, derived from disparate sources. By providing an architecture for electronic information and transaction exchange, a uniform mechanism can be effected the creation, capture, and analysis of a wide variety of process-related and health-relevant data pertinent to a patient.

With the invention, an individual patient can be viewed in a manner analogous to a product that is processed through a virtual production or supply chain. As described herein, the system and methods align complex and disparate processes and data, providing a common communication vehicle for the management of patient profiles, health conditions, medical treatments, and related billing and compensation matters.

Aspects of the invention further include providing linkage and integration of patient information with key medical and wellness processes. Other aspects include automatic updating of patent records, while also maintaining data security and patient privacy and enabling the validation of disparate data. Instant traceability of patient and other related information, the generation of measurements and reports of key performance indicators (e.g., performance, quality, compliance, and financial indicators), and the integration of information related to patient care, billing, and compensation are also some of the aspects of the invention. Still other aspects include the optimization of care and information processes by the creation of a single, uniform patient record and the enhancement of quality of care by unifying disparate processes and different forms associated with distinct processes. In all these respects, patient-specific information can be maintained in real-time and can follow the patient in both a geographical and time-related sense

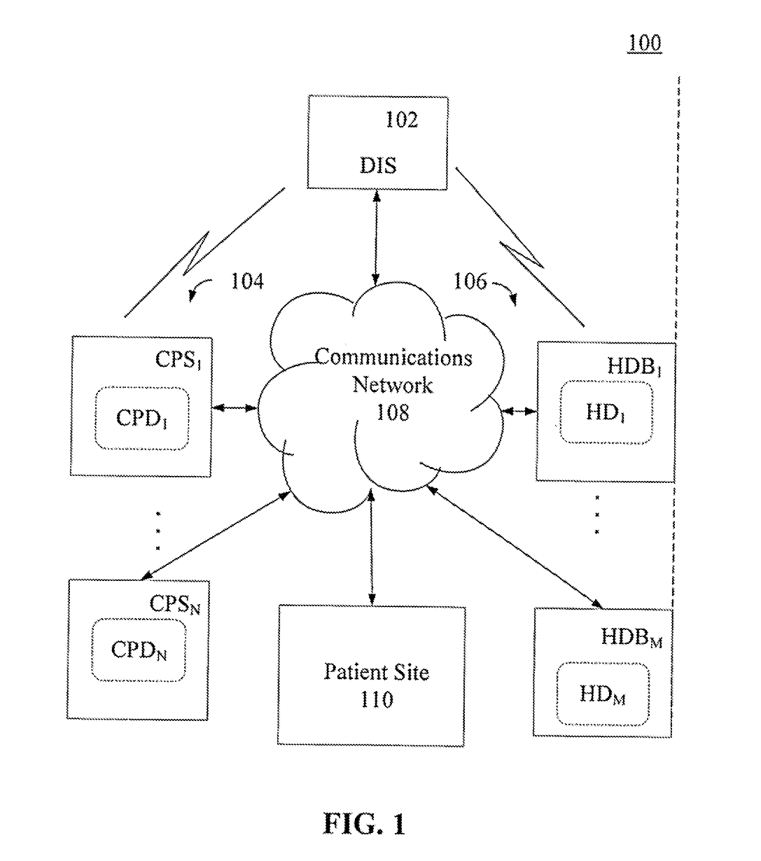

Referring initially to FIG. 1, a schematic view of an exemplary network environment 100 in which a system 102 for integrating disparate health-related procedures and health-related data is provided. The system 102, according to one embodiment, defines a dynamic integration system (DIS) for performing the operations and procedures described herein. The exemplary network environment 100 illustratively includes, in addition to the system 102, a plurality of care-provider sites CPSᵢ, i=1, . . . , N (collectively 104), and a plurality of health-related databases, HDBⱼ, j=1, . . . , M (collectively 106).

The system 102 is illustratively linked, wirelessly or through wire line connections, to the sites 104 and databases 106 through a data communications network 108. The data communications network 108 can be a local-area network (LAN), a wide-area network (WAN), or a connection of discrete networks, such as the Internet. Though not explicitly illustrated, it will be readily apparent that the system 102 alternately can be communicatively linked directly to one or more of the care-provider sites CPSᵢ, i=1, . . . N, and/or directly to one or more of the databases HDBⱼ, j=1, . . . M. Illustratively, the exemplary network environment 100 further shows a patient site 110 site communicatively linked to the system 102 through the data communications network 108, though the patient site alternatively can be communicatively linked directly to the system.

A care-provider site CPSᵢ, can correspond to a physician's site, a hospital site, a medical imaging site, a treatment center site, a medical laboratory site, and/or any similar healthcare-related site. Each care-provider site CPSᵢ, i=1, . . . N, can provide corresponding healthcare data, CPD, i=1, . . . N, to the system 102 for processing according to the procedures described herein. For example, a care-provider site CPSᵢ, pertaining to a physician's office can contain data CPD, corresponding to the physicians notes regarding an examination of a patient. A care-provider site CPS, of a medical imaging site can contain data CPD, corresponding to X-ray or MRI images, for example.

Similarly, each of the health-related databases, HDBⱼ, j=1, . . . M, can provide corresponding healthcare data, HDᵢ, i=1, . . . M, to the system 102 for processing according to the procedures also described herein. The healthcare data can pertain to a wide variety of topical issues. The healthcare data HDᵢ, i=1, . . . M, for example, can include analyses of the latest healthcare trends and recommendations advanced by various sources of unquestionable authority (e.g., universities, research institutions, insurance providers, and medial associations). Other healthcare data HDᵢ, i=1, . . . M, can provide analysis of lifestyle factors and/or environmental influences on health. Moreover, healthcare data HDᵢ, i=1, . . . M, can be patient-specific. For example, the healthcare data HDᵢ, i=1, . . . M, can pertain to patient billing information and/or patient insurance or compensation information. The integration of each of these disparate sources of information pertaining to processes and health-related data is, as described herein, a primary objective.

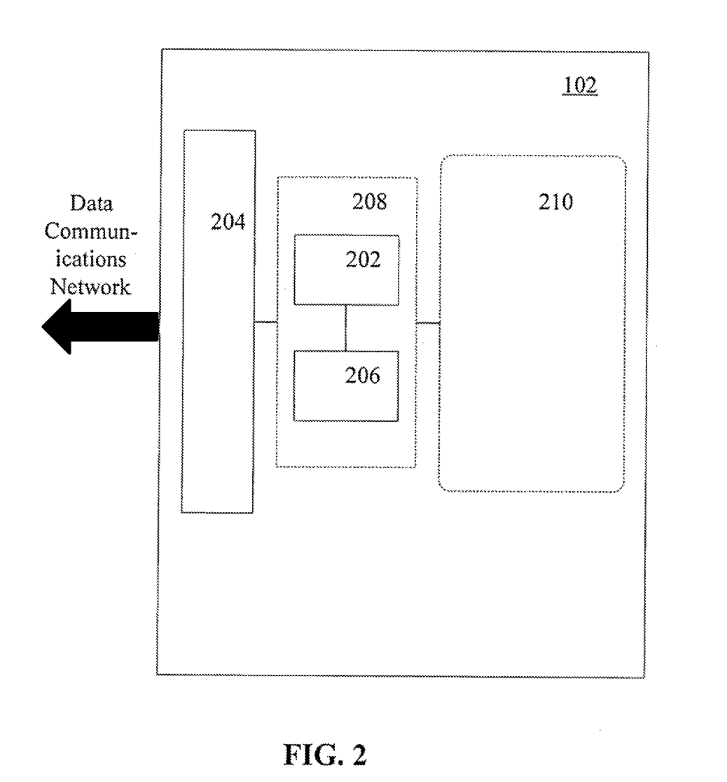

Referring additionally now to FIG. 2, a schematic view of the system 102 for integrating disparate health-related procedures and health-related data derived from disparate sources for an individual patient is provided. The system 102 illustratively includes a profile-generating module 202. Illustratively, the system 102 also includes an electronic interface 204 communicatively linked to the profile-generating module 202. The system 102 further illustratively includes a record-generating module 206, also communicatively linked to the profile-generating module 202.

Preferably, the profile-generating module 202 and the record-generating module 206 are implemented in computer-readable code that, when loaded on a computing system, causes the computing system to perform the various procedures and functions described herein. Accordingly, the system 102 optionally can include at least one processor 208 comprising registers, logic gates, and other logic-based circuitry (not shown) for executing computer-readable code. The system 102, optionally, can also include at least one memory element 210 for storing data and computer-readable code, as will be readily understood by one of ordinary skill in the art.

In an alternative embodiment, however, one or both the profile-generating module 202 and the record-generating module 206 can be implemented in dedicated, hardwired circuitry configured to perform the same procedures and functions. In still another embodiment, one or both the profile-generating module 202 and the record-generating module 206 can be implemented in a combination of computer-readable code and hardwired circuitry.

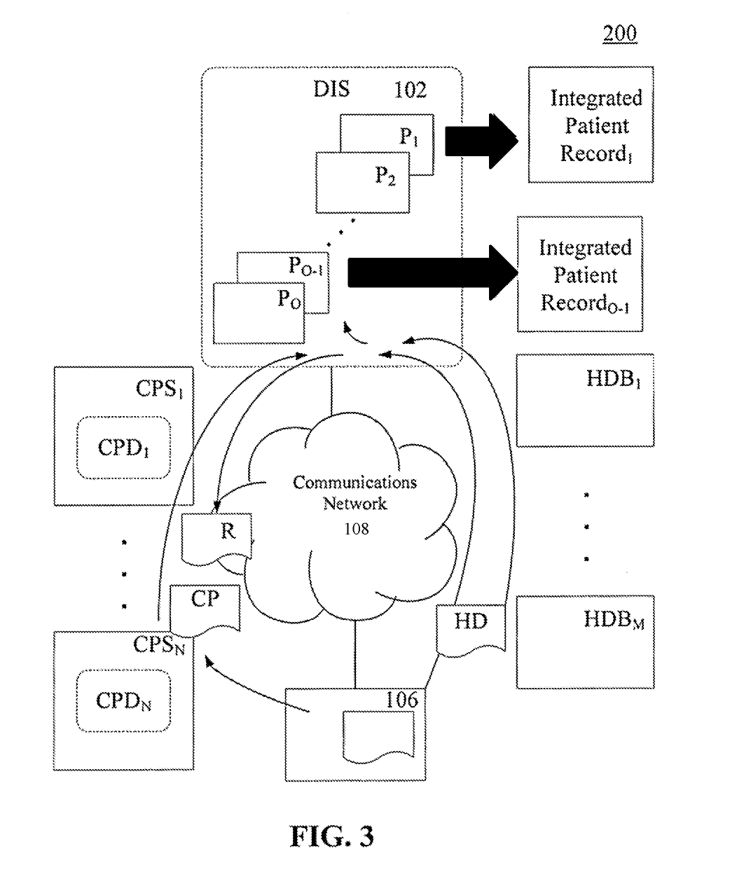

Referring additionally to FIG. 3, certain operative features of the system 102 are schematically illustrated. Operatively, the profile-generating module 202 generates an integrated patient profile for a patient. Illustratively, M different profiles, Pk, k=1 . . . 0, are generated for O different patients. Each such profile, Pk, can be based upon and/or comprise procedure-specific data obtained by performing one or more health-related procedures on the patient. When a patient visits various healthcare providers, related information for each visit is generated. This information can be aggregated and added to other patient-specific information (e.g., patient, name address, identification number, etc.) by the profile generating module 202.

As further illustrated schematically, the electronic interface 204 accesses health-related databases comprising health-related data pertinent to the patient. These databases can include one or more of the databases located at the care-provider sites CPSᵢ, i=1, . . . N, and/or one or more of the health-related databases, HDBⱼ, j=1, . . . M. Based on the integrated patient profile and health-related data, the record-generating module 206 generates an integrated patient record.

The profile-generating module 202 can be configured to update the integrated patient profile based upon procedure-specific data obtained for each subsequent health-related procedure performed on the patient. The procedure-specific data can be based upon examination notes prepared or generated by a healthcare professional (e.g., physician), results obtained from a laboratory procedure, and/or an image generated by a medical-imaging procedure (e.g., x-ray or MRI). Additionally or alternatively, the profile-generating module 202 can be configured to update the integrated patient profile based upon patient billing and compensation data (e.g., insurance information). As described more particularly below, the integrated patient profile also can incorporate disease management data and wellness management data.

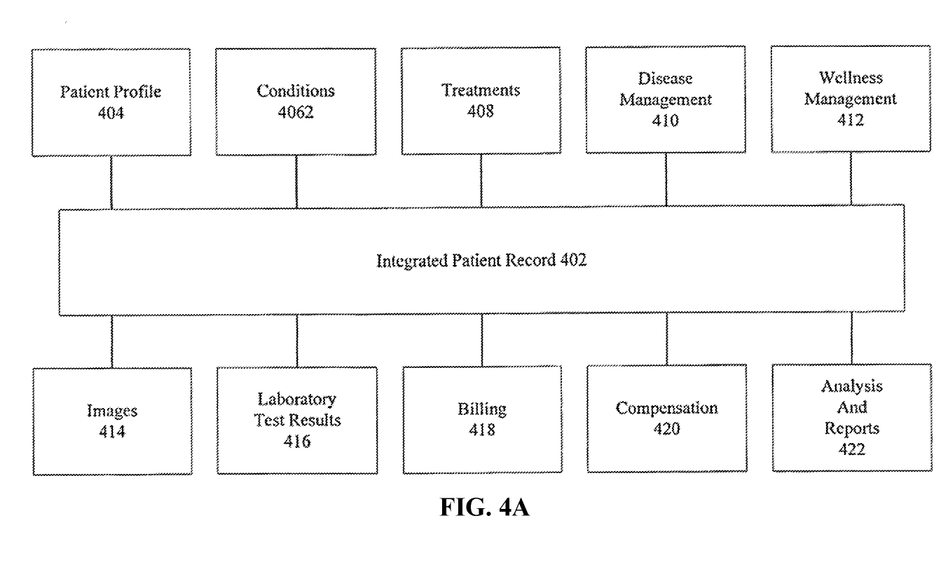

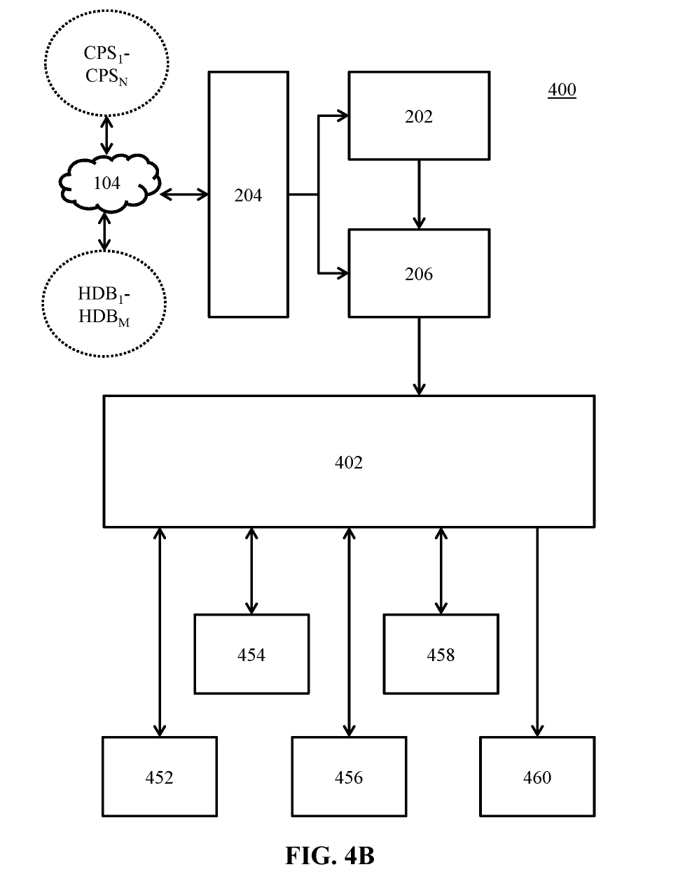

Referring additionally now to FIG. 4A, a schematic view is provided of an exemplary integrated patient record generated by a system 400 for integrating disparate health-related procedures and health-related data derived from disparate sources for an individual patient, according to another embodiment of the invention. FIG. 4B shows a schematic view of the various components in system 400. The integrated patient record 402, of the type described above and generated via record-generating module 206, can incorporate a patient profile 404, of the type described above and generated via profile-generating module 202. Additionally, the integrated patient record 402 can incorporate data 406 pertaining to a patient's medical condition. Accordingly, the system 400 can include a condition-documenting module 452 for documenting at least one health condition for the patient and inserting the at least one health condition into the integrated patient record.

The integrated patient record 402 can also incorporate data 408 describing planned medical treatments for the patient. Thus, the system 400 can comprise a treatment-plan-generating module for generating at least one treatment plan for the patient and inserting the at least one treatment plan into the integrated patient record 402. The treatment-plan-generating module 454 can be further configured to generate a compensation record corresponding to the treatment plan based upon a reconciliation of a billing record.

Additionally, or alternatively, the integrated patient record can incorporate data describing an extended disease management program for a patient 410. Therefore, the system 400 can include an extended disease-management-program-generating module 456 for generating an extended disease-management program based upon the integrated patient profile, a determined health condition of the patient, a treatment plan for the patient, and billing records pertaining to the patient. The system 400 can insert some or all aspects of the program into the integrated patient record 402.

Because the system 400 is able to access various health-related databases, the system is also able to suggest changes in lifestyle or identify environmental factors, for example, that may affect the patient's overall wellness. Thus the integrated patient record 402 can further incorporate a wellness management program 412 tailored to the particular patient. Accordingly, the system 400 can include a wellness-management-program-generating module 458 for generating a wellness-management program for the patient based upon the integrated patient profile, a determined health condition of the patient, a treatment plan for the patient, and billing records pertaining to the patient, and inserting the program into the integrated patient record.

As various procedures are performed on the patient, the results generated by these same procedures can be formatted into data for inclusion in the integrated patient record 402. Accordingly, medical images 414 and laboratory test results 416 can be included in the integrated patient record 402. Patient billing information 418 and compensation data 420 can be explicitly incorporated into the integrated patient record 402 as well. Based on a complete aggregation or any combination of these disparate data elements, various analyses can be performed and various reports 422 generated. Accordingly, the system 400 can further include an analyzing-and-reporting module 460 for generating at least one analysis and report based upon the integrated patient record.

In an exemplary situation, a particular patient visits one or more healthcare providers, each of whom provides patient-specific data pertaining to the patient's condition and/or treatment. The data, as already noted, can be aggregated by the system 400 with other patient-specific information to generate a particular patient profile. This, in turn, can be combined by the system 400 with data such as a physician's notes, laboratory results, and medical images (e.g., x-ray, Mm, etc.) to provide a comprehensive profile of the patient.

Health conditions of the patient can be documented and incorporated into the integrated patient record. A recommended treatment plan can specify certain medications, diet, and/or exercises for the patient. The treatment plan can be incorporated into the integrated patient record. Patient billing for services can be linked to related treatments by the system 400. Compensation from the patient's insurance provider can be calculated by the system 400, for example, based on existing tables so that the patient understands the nature of the treatment, the reason for the charges assessed, as well as the amount covered by the patient's insurance provider at the time that care was extended.

Any extended disease management or wellness management program, as already noted, can be incorporated into the integrated patient record by the system 400. The system can automatically perform different analyses and generate the various reports described above, which can be aggregated with a larger population size for the purpose of broader demographic analyses.

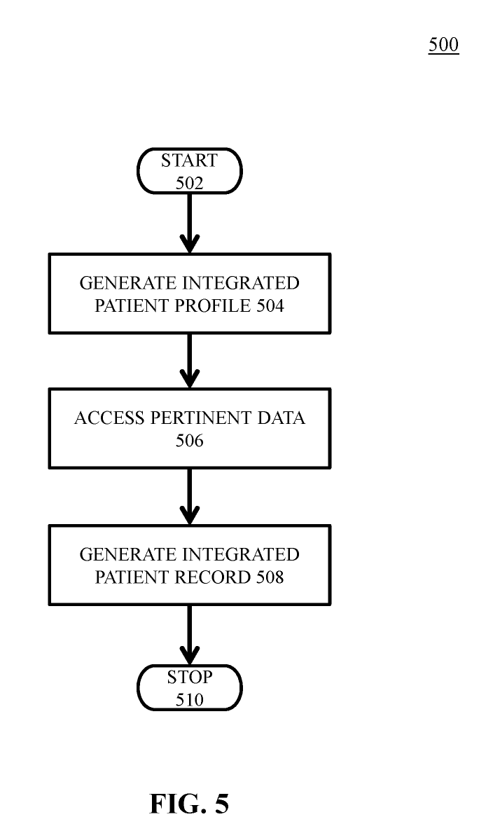

FIG. 5 is a flow chart illustrating certain method aspects. The flowchart illustrates a computer-implemented method 500 for integrating disparate health-related procedures and health-related data derived from disparate sources for an individual patient, according to one embodiment. The method includes, after the start at step 502, generating an integrated patient profile comprising procedure-specific data obtained by performing one or more health-related procedures on the patient at step 504. The method 500 further includes accessing health-related data pertinent to the patient at step 506. At step 508, the method 500 continues by creating an integrated patient record based upon the integrated patient profile and health-related data. The method 500 illustratively concludes at step 510.

According to one embodiment, the method 500 further includes updating the integrated patient profile for each subsequent health-related procedure performed on the patient based upon procedure-specific data. The procedure-specific data can be based upon at least one among notes generated by a healthcare professional, results obtained from a laboratory procedure, and an image generated by a medical-imaging procedure.

The method 500 can further include documenting at least one health condition for the patient and inserting the at least one health condition into the integrated patient record. According to yet another embodiment, the method can further include generating at least one treatment plan for the patient and inserting the at least one treatment plan into the integrated patient record. The method 500 can also include generating a billing record based on the at least one treatment plan. Additionally, the method can include generating a compensation record based upon a reconciliation of the billing record.

According to still another embodiment, the method 500 can further include generating an extended disease-management program. The extended disease-management program can be based upon the integrated patient profile, a determined health condition of the patient, a treatment plan for the patient, and billing records pertaining to the patient, and inserting the program into the integrated patient record. Additionally, or alternatively, the method 500 can include generating at least one wellness-management program for the patient. The program can be based upon the integrated patient profile, a determined health condition of the patient, a treatment plan for the patient, and billing records pertaining to the patient. The method 500 can further include inserting the wellness-management program into the integrated patient record. According to yet another embodiment, the method 500 can include generating at least one analysis and report based upon the integrated patient record.

The invention, as already noted, can be realized in hardware, software, or a combination of hardware and software. The invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The invention can be embedded in a computer program product, such as magnetic tape or an optically-readable disk, in which is embedded computer-readable code. The computer-readable code defines a computer program that, when loaded onto and executed by a computer, causes the computer or a computing system to implement the various methods described herein. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

The foregoing description of preferred embodiments of the invention have been presented for the purposes of illustration. The description is not intended to limit the invention to the precise forms disclosed. Indeed, modifications and variations will be readily apparent from the foregoing description. Accordingly, it is intended that the scope of the invention not be limited by the detailed description provided herein.

What is claimed is:

1. A method, comprising:
providing a patient records generating system for creating and maintaining integrated patient records for one or more patients, the recordkeeping system performing the steps of:
accessing, over a communications network, a plurality of disparate databases storing care provider data associated with the patients and other healthcare data pertinent to the patients,
generating an integrated patient profile for each of the patients based on the care provider data, and
generating the integrated patient records for each of the patients based on the corresponding integrated patient profile and the other healthcare data; and
providing a first automated agent that interfaces with the patient records generating system to update the integrated patient records, the first automated agent independently performing the steps of:
identifying at least one health condition for each of the patients based on the corresponding one of integrated patient records, and
documenting of the at least one health condition for each of the patients into the corresponding one of the integrated health records.

2. The method of claim 1, further comprising providing a second automated agent that interfaces with the patient records generating system to update the integrated patient records, the second automated agent independently performing the steps of:
generating a treatment plan for each of the patients based on the corresponding one of integrated patient records, and
inserting the treatment plan for each of the patients into the corresponding one of the integrated patient records.

3. The method of claim 2, wherein each of the integrated patient records further comprises billing records, and wherein the second automated further performs the step of generating a compensation record corresponding to the treatment plan for each of the patients based upon a reconciliation of the billing records in a corresponding one of the integrated health records.

4. The method of claim 1, wherein each of the integrated patient records further comprises billing records and a treatment plan, and further comprising providing a second automated agent that interfaces with the patient records generating system to update the integrated patient records, the second automated agent independently performing the steps of:
generating an extended disease management program for each of the patients based on for each of the patients based on the corresponding integrated health profile and the billing records, the treatment plan, and the documented at least one health condition from the corresponding one of integrated patient records, and
inserting at least a portion of the extended disease management program for each of the patients into the corresponding one of the integrated patient records.

5. The method of claim 1, wherein each of the integrated patient records further comprises billing records and a treatment plan, and further comprising providing a second automated agent that interfaces with the patient records generating system to update the integrated patient records, the second automated agent independently performing the steps of:
generating a wellness management program for each of the patients based on for each of the patients based on the corresponding integrated health profile and the billing records, the treatment plan, and the documented at least one health condition from the corresponding one of integrated patient records, and
inserting the wellness management program for each of the patients into the corresponding one of the integrated patient records.

6. The method of claim 1, further comprising providing a second automated agent that interfaces with the patient records generating system, the second automated agent independently performing the steps of:
extracting one or more type of data from the integrated patient records,
performing at least one analysis using the extracted data, and
generating a report based on the at least one analysis.

7. A patient records generating system for creating and maintaining integrated patient records for one or more patients, the patient records generating system comprising:
an electronic interface for accessing, over a communications network, a plurality of disparate databases storing care provider data associated with the patients and other healthcare data pertinent to the patients,
a profile-generating module for generating an integrated patient profile for each of the patients based on the care provider data, and
a record-generating module for generating the integrated patient records for each of the patients based on the corresponding integrated patient profile and the other healthcare data; and
a condition documenting module for independently updating the integrated patient records by identifying at least one health condition for each of the patients based on the corresponding one of integrated patient records, and documenting of the at least one health condition for each of the patients into the corresponding one of the integrated health records.

8. The system of claim 7 further comprising a treatment-plan generating module for independently updating the integrated patient records by:
generating a treatment plan for each of the patients based on the corresponding one of integrated patient records, and
inserting the treatment plan for each of the patients into the corresponding one of the integrated patient records.

9. The system of claim 8, wherein each of the integrated patient records further comprises billing records, and wherein the treatment-plan generating module further updates the integrated patient records by generating a compensation record corresponding to the treatment plan for each of the patients based upon a reconciliation of the billing records in a corresponding one of the integrated health records.

10. The system of claim 7, wherein each of the integrated patient records further comprises billing records and a treatment plan, and further comprising an extended disease-management-program-generating module for independently updating the integrated patient records by:
generating an extended disease management program for each of the patients based on for each of the patients based on the corresponding integrated health profile and the billing records, the treatment plan, and the documented at least one health condition from the corresponding one of integrated patient records, and
inserting at least a portion of the extended disease management program for each of the patients into the corresponding one of the integrated patient records.

11. The system of claim 7, wherein each of the integrated patient records further comprises billing records and a treatment plan, and further comprising a wellness-management-program-generating module for independently updating the integrated patient records by:
generating a wellness management program for each of the patients based on for each of the patients based on the corresponding integrated health profile and the billing records, the treatment plan, and the documented at least one health condition from the corresponding one of integrated patient records, and
inserting the wellness management program for each of the patients into the corresponding one of the integrated patient records.

12. The system of claim 7, further comprising an analyzing-and-reporting module for independently:
extracting one or more type of data from the integrated patient records,
performing at least one analysis using the extracted data, and
generating a report based on the at least one analysis.

13. A non-transitory computer readable medium having stored there a computer program executable by a computer, the computer program comprising a plurality of code sections for causing the computer to perform the steps of:
providing a patient records generating system for creating and maintaining integrated patient records for one or more patients, the recordkeeping system performing the steps of:
accessing, over a communications network, a plurality of disparate databases storing care provider data associated with the patients and other healthcare data pertinent to the patients,
generating an integrated patient profile for each of the patients based on the care provider data, and
generating the integrated patient records for each of the patients based on the corresponding integrated patient profile and the other healthcare data; and
providing a first automated agent that interfaces with the patient records generating system to update the integrated patient records, the first automated agent independently performing the steps of:
identifying at least one health condition for each of the patients based on the corresponding one of integrated patient records, and
documenting of the at least one health condition for each of the patients into the corresponding one of the integrated health records.

14. The computer-readable medium of claim 13, further comprising code sections for providing a second automated agent that interfaces with the patient records generating system to update the integrated patient records and that independently performs the steps of:
generating a treatment plan for each of the patients based on the corresponding one of integrated patient records, and
inserting the treatment plan for each of the patients into the corresponding one of the integrated patient records.

15. The computer-readable medium of claim 14, wherein each of the integrated patient records further comprises billing records, and wherein the second automated further performs the step of generating a compensation record corresponding to the treatment plan for each of the patients based upon a reconciliation of the billing records in a corresponding one of the integrated health records.

16. The computer-readable medium of claim 13, wherein each of the integrated patient records further comprises billing records and a treatment plan, and further comprising code sections for providing a second automated agent that interfaces with the patient records generating system to update the integrated patient records and that independently performs the steps of:
generating an extended disease management program for each of the patients based on for each of the patients based on the corresponding integrated health profile and the billing records, the treatment plan, and the documented at least one health condition from the corresponding one of integrated patient records, and
inserting at least a portion of the extended disease management program for each of the patients into the corresponding one of the integrated patient records.

17. The method of claim 13, wherein each of the integrated patient records further comprises billing records and a treatment plan, and further comprising code sections for providing a second automated agent that interfaces with the patient records generating system to update the integrated patient records and independently perform the steps of:
generating a wellness management program for each of the patients based on for each of the patients based on the corresponding integrated health profile and the billing records, the treatment plan, and the documented at least one health condition from the corresponding one of integrated patient records, and
inserting the wellness management program for each of the patients into the corresponding one of the integrated patient records.

18. The method of claim 13, further comprising code sections for providing a second automated agent that interfaces with the patient records generating system to update the integrated patient records and independently perform the steps of:
extracting one or more type of data from the integrated patient records,
performing at least one analysis using the extracted data, and
generating a report based on the at least one analysis.
